(19) United States
(12) Patent Application Publication
(10) Pub. No.: US 2014/0075370 A1
(43) Pub. Date: Mar. 13, 2014

(54) Dockable Tool Framework for Interaction with Large Scale Wall Displays

(71) Applicant: The Johns Hopkins University, Baltimore, MD (US)

(72) Inventors: Kelleher Riccio Guerin, Baltimore, MD (US); Gregory Hager, Baltimore, MD (US)

(73) Assignee: The Johns Hopkins University, Baltimore, MD (US)

(21) Appl. No.: 14/026,152

(22) Filed: Sep. 13, 2013

Related U.S. Application Data
(60) Provisional application No. 61/700,605, filed on Sep. 13, 2012.

(51) Int. Cl. G06F 3/0481; G06F 3/0482

(52) U.S. Cl. CPC G06F 3/04815; G06F 3/0482
USPC 715/779

(57) ABSTRACT

In accordance with an aspect of the present invention, a device and a method allows for body-based interaction with 3D applications on wall displays. The interface consists of virtual dockable tools which can be unholstered, used to manipulate geometry, and holstered on the user's body. The system also utilizes proprioceptive cues to allow the user to manipulate and holster tools without visual feedback. A 3D depth camera maps 3D user position to 3D coordinates in the virtual scene. Partitioning the physical work space into a region for interaction with geometry, and a region for tool management allows for intuitive mapping between the physical and virtual work space. The system can support multiple users, including simultaneous interaction with the environment, and tool exchange between users.

### CROSS REFERENCE TO RELATED APPLICATION

This application claims the benefit of U.S. Provisional Patent Application No. 61/700,605, filed on Sep. 13, 2012, which is incorporated by reference herein in its entirety.

### GOVERNMENT SPONSORSHIP

This invention was made with government support under NSF CPS-0931805 awarded by the National Science Foundation. The government has certain rights in the invention.

### FIELD OF THE INVENTION

The present invention relates generally to computing. More particularly, the present invention relates to a tool framework for large scale displays.

### BACKGROUND OF THE INVENTION

Most commonly, computing platforms include a screen sized for use on a personal desk or a laptop. A user can interact with these screens using a point-and-click type mouse, a touchpad, or a touchscreen. However, wall display are increasingly becoming a popular platform for computing, visualization, 2D and 3D manipulation, brainstorming, decreasing costs in display hardware such as high resolution flat panel displays and projectors. The increasing amount of high resolution content for both entertainment and scientific analysis has also made wall displays more than just novelty devices. Large scale wall displays offer unique advantages over small desktop displays. The large number of pixels, from tens of megapixels to gigapixel resolution, allows a one-to-one un-cropped display of very high resolution images. The large size of a wall display also affords a proportionately large workspace in front of the wall, which is necessary for multiuser interaction. Large multi-monitor or wall displays have also shown to increase productivity for a given task over a smaller or single monitor display. Finally, because it often fills much of the user's peripheral vision, a large wall display offers an immersive experience to virtual reality, especially when the screen is displaying a physical or virtual environment.

The wall display can be used as a tool for 3D content generation and manipulation. The use of wall displays for this purpose has been much less studied than the display of static 2D or 3D content. Such applications include CAD, architectural, and art applications. The large size of wall displays and the relatively large working distance (how far the user stands or sits from the display), makes interaction with traditional WIMP (Windows Icon Menu Pointer) methods impractical, unless graphical widgets are scaled up, thus reducing the usefulness of the high resolution. Manipulation of objects in 3D offers its own challenges, apart from the inherent interface challenges with wall displays. First, the mapping between the user and the 3D interface is more complex than for a 2D interface. Second, the creation of geometry often requires more precise control, increased tool complexity and nuanced interaction than simply viewing existing geometry and data.

Large scale wall displays necessitate new paradigms for interaction with immersive 3D applications like 3D content generation and visualization programs such as Computer Aided Drafting (CAD) and architectural design suites. However, the large size of these displays prevents effective use of traditional 3D input methods for desktop applications.

One prior publication describes a method of using wall displays for automotive design, and providing wall display analogs for physical design practices such as tape drawing. Another publication then extended this work into 3D, allowing for two-handed interaction with a 3D volumetric representation of an automobile as well as intuitive camera control. This work, however, used hand-held devices for tracking and afforded only 2D input. Most recently, a publication demonstrated 3D manipulation of geometry on a large display using the 3D input method of infrared LED equipped gloves and Nintendo Wiimotes.

It would therefore be advantageous to provide a simplified system and method for three-dimensional interaction with a large-scale wall display.

### SUMMARY OF THE INVENTION

The foregoing needs are met, to a great extent, by the present invention, wherein in one aspect a method of providing three-dimensional interaction with a workspace displayed on a large-scale wall display includes providing a non-transitory computer readable medium programmed for capturing a user's movements and translating the user's movements into a first command to remove a dockable virtual tool from a holster. The method also includes translating the user's movements into a second command to move and use the tool and translating the user's movements into a third command to return the dockable virtual tool to the holster.

In accordance with an aspect of the present invention, the tool further includes at least one chosen from the group consisting of a tool to move geometry, a tool to scale geometry, a tool to rotate geometry, a tool to create new geometry, a tool to delete geometry, a tool to augment geometry, and a tool to perform Boolean operations on geometry. The holster is attached directly to a user's avatar in the workspace. The method can further include using proprioceptive cues for accessing tools, and using an actable to trigger discrete events when a cursor controlled by a user is nearby.

In accordance with another aspect of the present invention, a method of providing three-dimensional interaction with a workspace on a large-scale wall display includes providing a non-transitory computer readable medium programmed for providing a dockable virtual tool in the workspace, wherein said dockable virtual tool resides in a holster when said dockable virtual tool is not in use. The method includes a step of partitioning the workspace into a first region and a second region, said first region being configured for a user's interaction with geometry within the workspace, and said second region being configured for management of the dockable virtual tool. The method also includes a step of capturing the user's movements, and a step of translating the user's movements into a command to control the dockable virtual tool.

In accordance with an aspect of the present invention, the tool further includes at least one chosen from the group consisting of a tool to move geometry, a tool to scale geometry, a tool to rotate geometry, a tool to create new geometry, a tool to delete geometry, a tool to augment geometry, and a tool to perform Boolean operations on geometry. The holster is attached directly to a user's avatar in the workspace. The method can further include using proprioceptive cues for accessing tools, and using an actable to trigger discrete events when a cursor controlled by a user is nearby.

In accordance with yet another aspect of the present invention, a system for providing three-dimensional interaction with a workspace on a large-scale wall display includes a single-range camera configured and positioned to collect movement data from a user and a non-transitory computer readable medium programed to execute steps. The programmed steps include displaying a virtual dockable tool on the large-scale wall display and displaying a holster for holding the virtual dockable tool when said virtual dockable tool is not in use. The programmed steps also include translating the movement data from the user collected by the single-range camera into commands to control the virtual dockable tool.

In accordance with still another aspect of the present invention, the tool can take the form of a tool to move geometry, a tool to scale geometry, a tool to rotate geometry, a tool to create new geometry, a tool to delete geometry, a tool to augment geometry, and a tool to perform Boolean operations on geometry. The holster is attached directly to a user's avatar in the workspace. The tool is controllable with proprioceptive cues. Additionally, an actable is configured to trigger discrete events when a cursor controlled by a user is nearby.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 illustrates a schematic diagram of a framework for interacting with a large scale wall display, according to an embodiment of the present invention.

FIG. 2 illustrates a schematic diagram of a framework for a user interface device and computing device according to an embodiment of the present invention.

FIG. 3 illustrates a schematic diagram of a framework for interacting with a large scale wall display, according to an embodiment of the present invention.

FIG. 4 illustrates a flow diagram of a method of interacting with the large scale wall display, according to an embodiment of the present invention.

FIG. 5 illustrates a flow diagram of a second method of interacting with the large scale wall display, according to an embodiment of the present invention.

FIG. 6A and FIG. 6B illustrates images of the workspace partition, according to an embodiment of the present invention.

FIG. 7 illustrates a schematic diagram of a physical workspace and a coordinate frame of the physical workspace, according to an embodiment of the present invention.

FIGS. 8A-8D illustrate schematic diagrams of a holster and cursor, according to an embodiment of the present invention.

FIG. 9 illustrates a photograph of the system in use, according to an embodiment of the present invention.

FIG. 10 illustrates a flow diagram of cursor function according to an embodiment of the present invention.

FIGS. 11A and 11B illustrate images a user switching a tool between hands in the virtual environment, according to an embodiment of the present invention.

FIGS. 12A-12C illustrate schematic diagrams of three different icons, according to an embodiment of the present invention.

FIGS. 13A-13B illustrates image of multiple users interacting in the workspace.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In accordance with an aspect of the present invention, a device and a method allows for body-based interaction with 3D applications on wall displays. The interface consists of virtual dockable tools which can be unholstered, used to manipulate geometry, and holstered on the user's body. The system also utilizes proprioceptive cues to allow the user to manipulate and holster tools without visual feedback. A 3D depth camera maps 3D user position to 3D coordinates in the virtual scene. Partitioning the physical work space into a region for interaction with geometry, and a region for tool management allows for intuitive mapping between the physical and virtual work space. The system can support multiple users, including simultaneous interaction with the environment, and tool exchange between users.

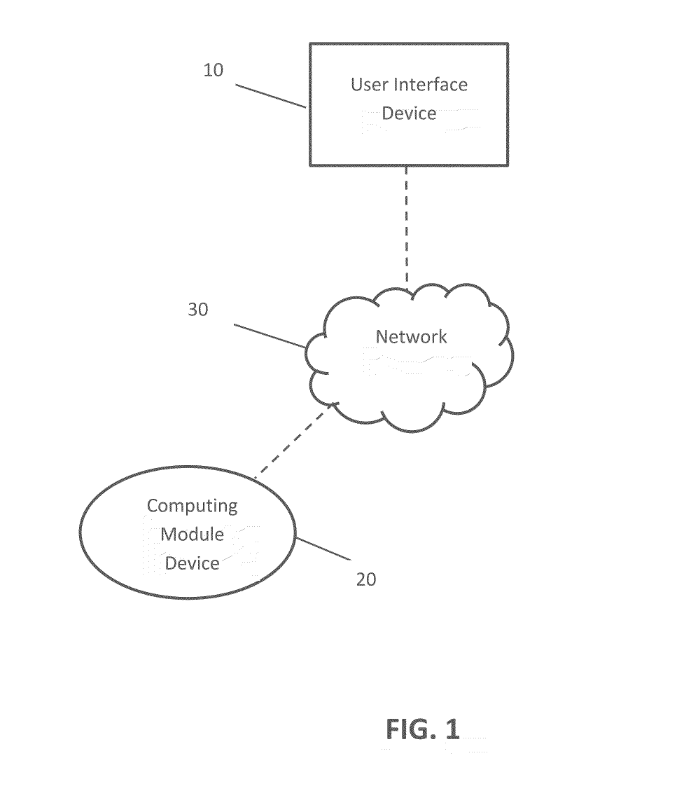

In one embodiment, illustrated in FIG. 1, the framework for interacting with a large scale wall display can include a user interface device 10, and a computing device 20. The computing device 20 may be a general computing device, such as a personal computer (PC), a UNIX workstation, a server, a mainframe computer, a personal digital assistant (PDA), smartphone, cellular phone, a tablet computer, a slate computer, or some combination of these. Alternatively, the computing device 20 may be a specialized computing device conceivable by one of skill in the art. The remaining components may include programming code, such as source code, object code or executable code, stored on a computer-readable medium that may be loaded into the memory and processed by the processor in order to perform the desired functions of the system. The user interface device 10 can include a large scale wall display and depth camera, which will be described in further detail, herein.

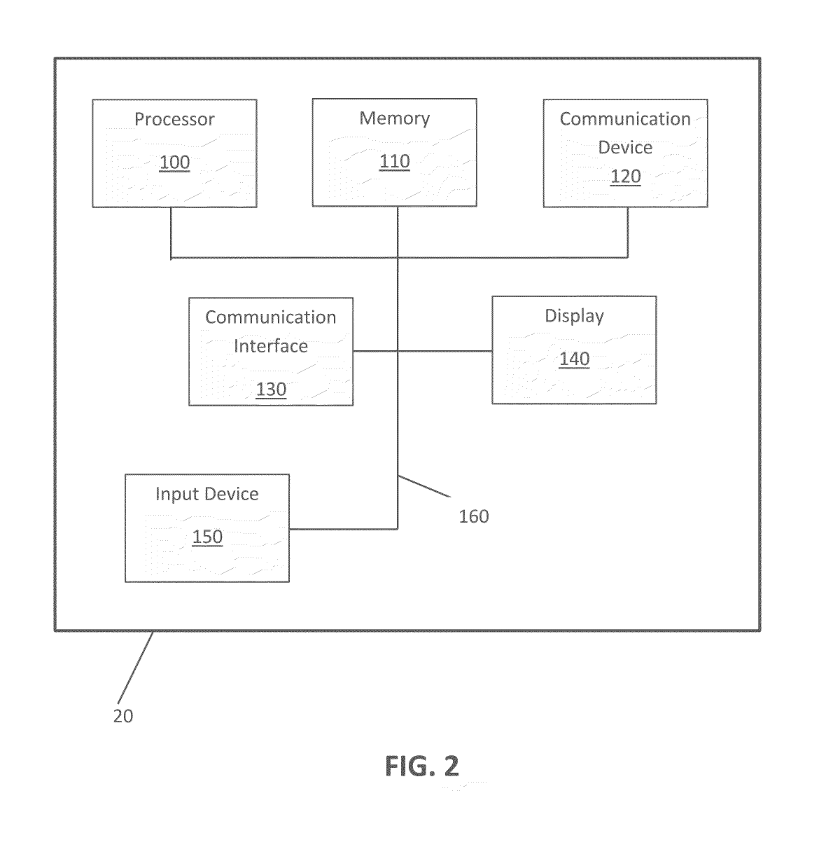

The user interface device 10 and the computing device 20 may communicate with each other over a communication network 30 via their respective communication interfaces as exemplified by element 130 of FIG. 2. The communication network 30 can include any viable combination of devices and systems capable of linking computer-based systems, such as the Internet; an intranet or extranet; a local area network (LAN); a wide area network (WAN); a direct cable connection; a private network; a public network; an Ethernet-based system; a token ring; a value-added network; a telephony-based system, including, for example, T1 or E1 devices; an Asynchronous Transfer Mode (ATM) network; a wired system; a wireless system; an optical system; cellular system; satellite system; a combination of any number of distributed processing networks or systems or the like.

Referring now to FIG. 2, the computing device 20 can each include a processor 100, a memory 110, a communication device 120, a communication interface 130, a large scale display 140, an input device 150, and a communication bus 160, respectively. The processor 100, may be executed in different ways for different embodiments of the computing device 20. One option is that the processor 100, is a device that can read and process data such as a program instruction stored in the memory 110, or received from an external source. Such a processor 100, may be embodied by a microcontroller. In other embodiments, the processor 100 may be a collection of electrical circuitry components built to interpret certain electrical signals and perform certain tasks in response to those signals, or the processor 100, may be an integrated circuit, a field programmable gate array (FPGA), a complex programmable logic device (CPLD), a programmable logic array (PLA), an application specific integrated circuit (ASIC), or a combination thereof Different complexities in the programming may affect the choice of type or combination of the above to comprise the processor 100.

Similarly to the choice of the processor 100, the configuration of a software of the user interface device 10 and the computing device 20 (further discussed herein) may affect the choice of memory 110, used in the user interface device 10 and the computing device 20. Other factors may also affect the choice of memory 110, type, such as price, speed, durability, size, capacity, and reprogrammability. Thus, the memory 110, of the computing device 20 may be, for example, volatile, non-volatile, solid state, magnetic, optical, permanent, removable, writable, rewriteable, or read-only memory. If the memory 110, is removable, examples may include a CD, DVD, or USB flash memory which may be inserted into and removed from a CD and/or DVD reader/writer (not shown), or a USB port (not shown). The CD and/or DVD reader/writer, and the USB port may be integral or peripherally connected to user interface device 10 and the computing device 20.

In various embodiments, user interface device 10 and the computing device 20 may be coupled to the communication network 30 (see FIG. 1) by way of the communication device 120. In various embodiments the communication device 120 can incorporate any combination of devices—as well as any associated software or firmware—configured to couple processor-based systems, such as modems, network interface cards, serial buses, parallel buses, LAN or WAN interfaces, wireless or optical interfaces and the like, along with any associated transmission protocols, as may be desired or required by the design.

Working in conjunction with the communication device 120, the communication interface 130 can provide the hardware for either a wired or wireless connection. For example, the communication interface 130, may include a connector or port for an OBD, Ethernet, serial, or parallel, or other physical connection. In other embodiments, the communication interface 130, may include an antenna for sending and receiving wireless signals for various protocols, such as, Bluetooth, Wi-Fi, ZigBee, cellular telephony, and other radio frequency (RF) protocols. The user interface device 10 and the computing device 20 can include one or more communication interfaces 130, designed for the same or different types of communication. Further, the communication interface 130, itself can be designed to handle more than one type of communication.

Additionally, an embodiment of the user interface device 10 and the computing device 20 may communicate information to the user through the large scale display 140, and request user input through the input device 150, by way of an interactive, visual display-based user interface, or graphical user interface (GUI). The input device 150, in this case, is a depth camera that allows for the user to interact directly with the large scale wall display 140 using motions and tools configured for direct user interaction, which will be described further herein.

The different components of the user interface device 10 and the computing device 20 can be linked together, to communicate with each other, by the communication bus 160. In various embodiments, any combination of the components can be connected to the communication bus 160, while other components may be separate from the user interface device 10 and the computing device 20 and may communicate to the other components by way of the communication interface 130.

Some applications of the framework for interacting with a large scale wall display may not require that all of the elements of the system be separate pieces. For example, in some embodiments, combining the user interface device 10 and the computing device 20 may be possible. Such an implementation may be usefully where internet connection is not readily available or portability is essential.

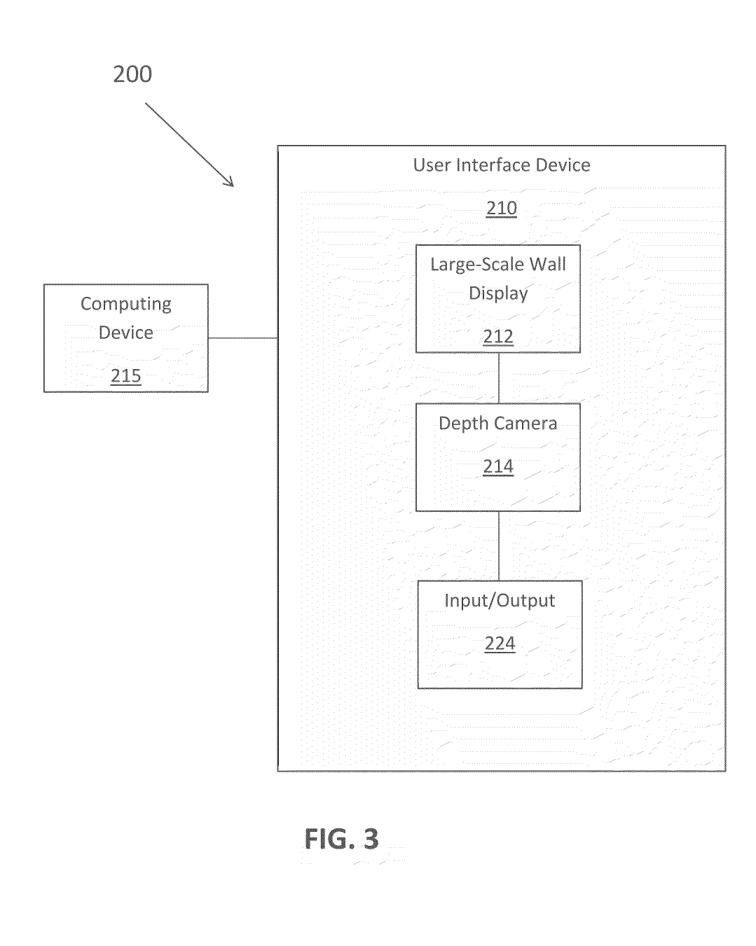

FIG. 3 illustrates a schematic diagram of the framework for interacting with the large scale wall display 200, according to an embodiment of the invention. The user interface device 210 includes a large scale wall display 212, a depth camera 214, and can possibly include an input/output device 224. The computing device 215 contains programs, software, and/or an internet/intranet connection for allowing the user to interact with the large scale wall display that will be discussed further herein. The large scale wall display 212 is also configured to communicate with the computing device 215 either via wired or wireless communication.

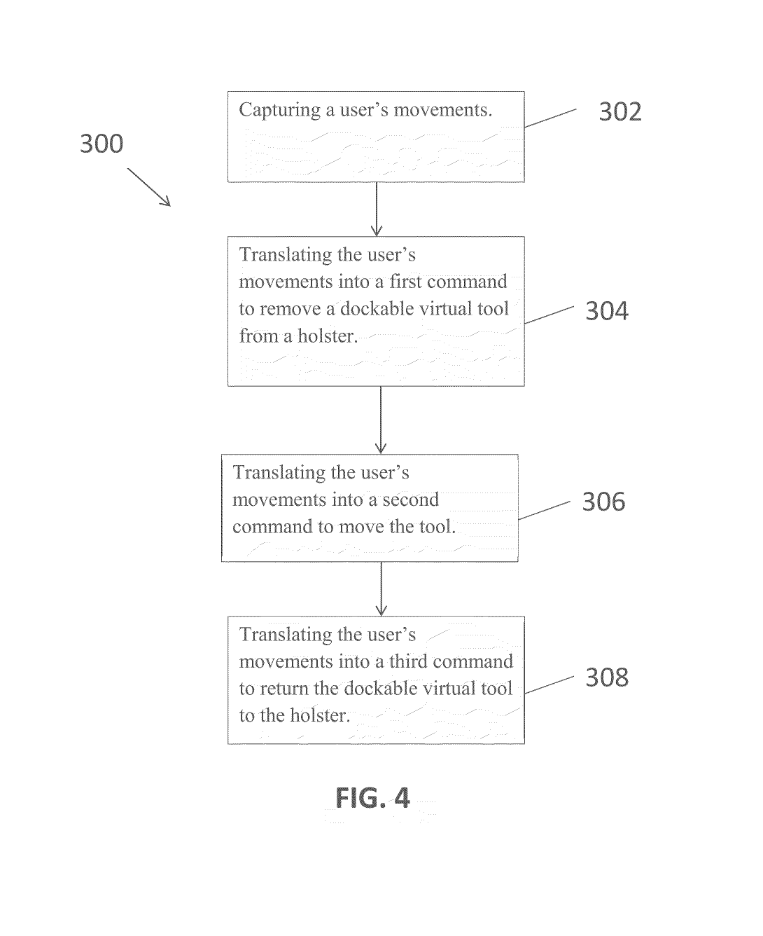

FIG. 4 illustrates a method 300 of providing three-dimensional interaction with a workspace displayed on a large-scale wall display including a step 302 of capturing a user's movements. The method also includes step 304 of translating the user's movements into a first command to remove a dockable virtual tool from a holster. Step 306 includes translating the user's movements into a second command to move and use the tool, and step 308 includes translating the user's movements into a third command to return the dockable virtual tool to the holster.

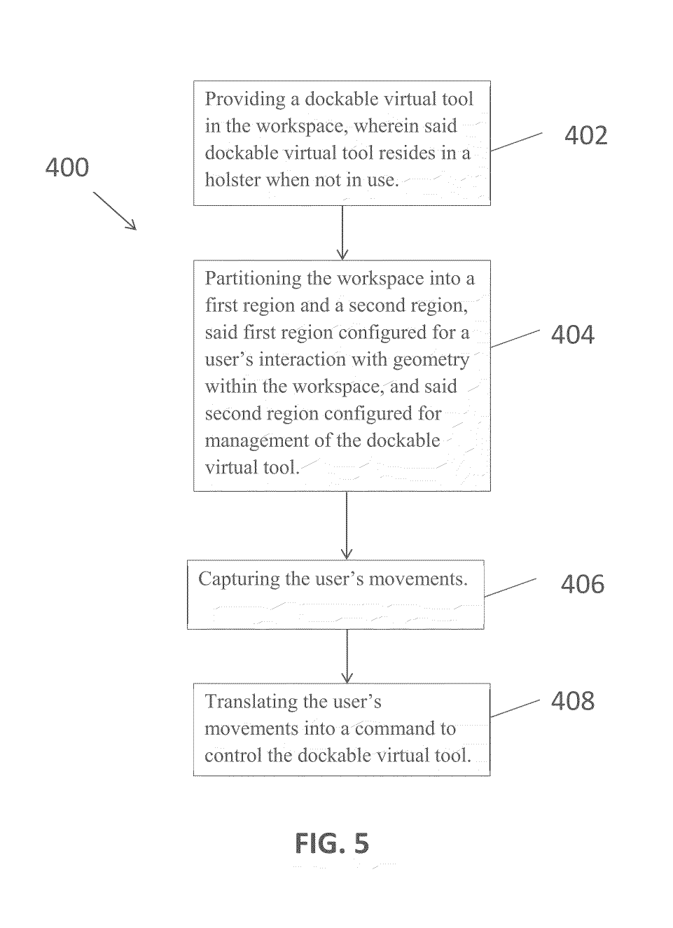

FIG. 5 illustrates a method 400 of providing three-dimensional interaction with a workspace on a large-scale wall display including a step 402 of providing a dockable virtual tool in the workspace, wherein said dockable virtual tool resides in a holster when said dockable virtual tool is not in use. Step 404 includes partitioning the workspace into a first region and a second region, said first region configured for a user's interaction with geometry within the workspace, and said second region configured for management of the dockable virtual tool. The method also includes step 406 of capturing the user's movements, and step 408 of translating the user's movements into a command to control the dockable virtual tool.

The framework includes dockable virtual tools for performing tasks in the 3D environment, which can be attached to 3D user cursors and placed in virtual holsters either on the user's body or directly in the virtual workspace. Dockable buttons called actables can also be included. The dockable buttons can be placed in holsters for use, or linked with tools to provide additional functionality. A method for partitioning the physical user workspace is also included to switch interaction modes in the virtual environment. An application within the system allows for geometry manipulation with a collection of dockable tools that supports multiple users.

The present invention takes advantage of the large physical workspace of the wall. Body-based interfaces can take advantage of the user's many degrees of freedom and nearby space to perform complex, intuitive interaction. Body-based and reality-based interaction can be used with Virtual Reality/Virtual Environment applications. A user interacts from inside the environment, such as the user being embedded in the virtual environment.

Tool Management Virtual environments allow tools to occupy the same space as the content or information they can manipulate. This counters the traditional WIMP tool paradigm, where tools are constrained to a pallet object as part of an overlay or drop down menu.

Using a depth camera, the present invention maps the physical workspace directly into the virtual environment. While interaction with geometry is governed by a strict set of rules, it is still possible that errant motions by the user while resting or conversing could inadvertently cause events. It is also desirable for the user to have an overview of the virtual environment. Finally, a region in virtual space devoted to the selection and configuration of tools is also useful. Therefore, the physical workspace of the present invention is partitioned into two regions.

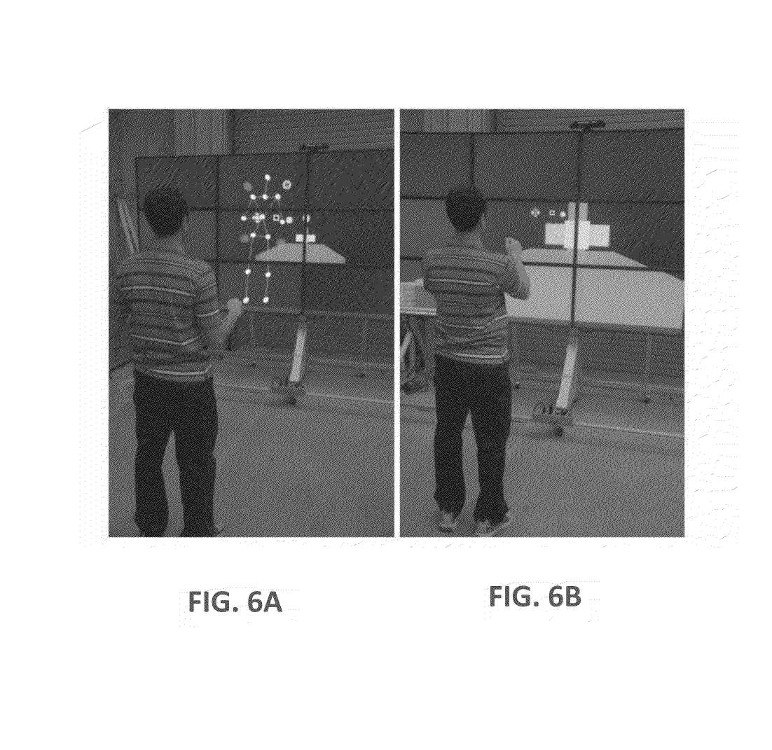

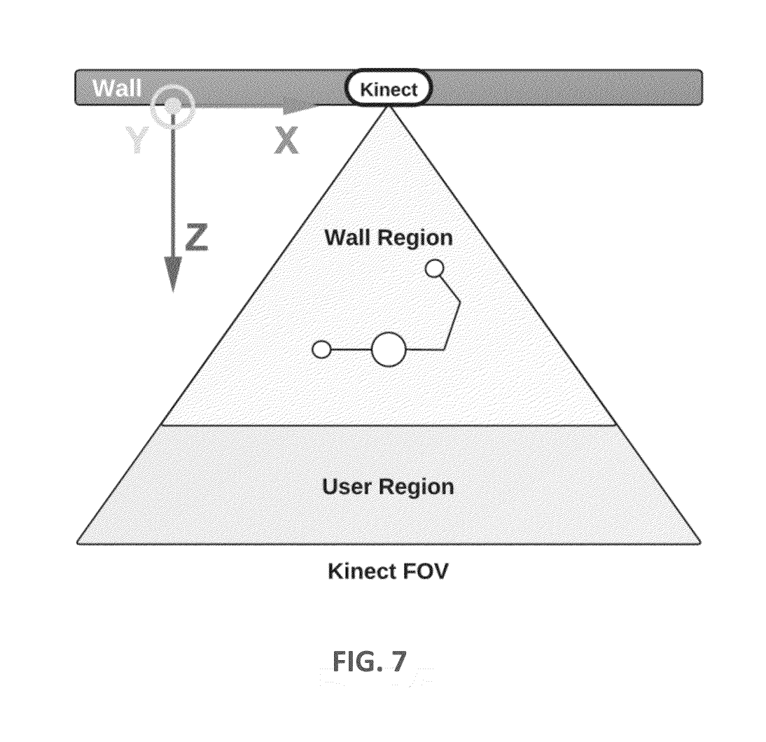

The virtual workspace partition is shown in FIGS. 6A and 6B. The physical workspace partitioning, as well as the coordinate frame of the physical workspace is illustrated in FIG. 7. Positive Z points out of the wall, positive Y points up from the wall, and positive X points to a user's right as they face the wall. Motion between the two physical regions invokes a transition between two views of the virtual workspace. The first region is denoted as userspace. In this region a user sees a zoomed out view of the scene. This region corresponds to the physical area approximately 2.5-4 meters from the wall. In the foreground, a user sees his or her fully articulated 3D skeleton which shows the motions of the user's body. Because a users' movement in Z invokes the transition between wallspace and userspace, and the vertical movement of the user is limited, the skeleton is fixed in Y and Z position by the torso joint, but free in X and rotation. This allows the user to move left or right before the screen, and in rotation, and have the skeleton follow. Userspace is for explicitly interacting with tools and other users and suspending interaction with the scene, while the next region, wallspace, is intended for manipulating geometry and the scene.

The second region is referred to as wallspace. In the physical workspace, wallspace corresponds to an area 1-2.5 meters from the display. A user standing in this region is presented with a close up, immersive view of the scene, or the region of the virtual environment containing geometry to manipulate. In this region two spherical cursors, corresponding to a user's hands, are the only representation of the user's body. The position of the cursors in the virtual environment is scaled so that it appears to match actual motion of the users' arms. The hand/cursor position is in world, not body coordinates, so that gross motion of the user in the physical workspace also moves the cursor (i.e. the user translates the cursor either by moving his or her hand, or walking) Interaction in wallspace is based on moving the cursors in 3D to intersect with the geometry to be manipulated.

In wallspace, the range of motion of a user's virtual cursors is limited by a user's physical workspace. Thus, some geometry may be out of reach for the user. The problem is mitigated by solutions from virtual environment interaction, and moves the scene relative to the user, keeping the same scaling factor between the physical and virtual space. The mechanism for creating this motion is a dedicated tool which can be used by the user to rotate the scene. This gives the user the ability to reach anywhere in the scene, while keeping the same scaling and interaction, and using the same proprioceptive cues.

Different tools are used within the framework to invoke different actions on geometry within the virtual environment. Tools could include functionality to move scale or rotate geometry, create new geometry, delete geometry, augment geometry, perform Boolean operations on geometry etc. Any other tool known to or conceivable by one of skill in the art could also be used. Tools to manipulate the virtual environment, as mentioned in the workspace management section, are also used such as a tool for rotating the view.

The dockable tool is defined by a visual icon and a behavior when interacting with other objects. The icon's manifestation can be a 3D geometric object or a 2D billboard like image. The docking dynamics of all tools are defined by the finite state machine shown in FIG. 6.

A dockable tool can dock with two other geometry constructs: cursors and holsters. A holster is a geometry object which sits at a fixed position in world coordinates, or relative to another geometric object. An empty holster has a fixed size, and is displayed by a transparent sphere. Dockable tools begin assigned to specific holsters. The icon of a holstered tool is fixed to the holster, and the holster's sphere icon is hidden. Any motion by the holster causes the tool's icon to move in the same manner.

Holsters can both be attached to the user or fixed to the wall. Holsters can be attached directly and rigidly to the user's skeleton avatar in userspace. This enables proprioceptive cues for remembering tool locations and quickly accessing them. Also, it is important to note that when a user is in wallspace, tools can still be holstered and unholstered using only proprioceptive cues.

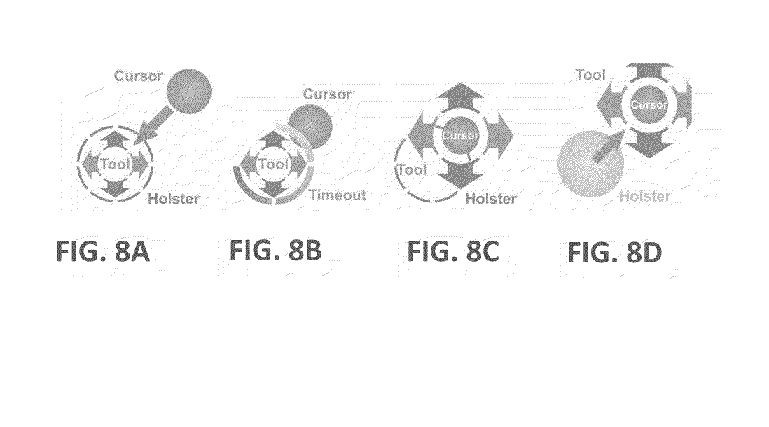

When a user wishes to use a tool, he or she places his cursor in proximity to the 3D position of the holster. After a timeout period, the dockable tool unholsters itself from the holster and docks itself to the cursor. This action follows the intuitive metaphor of a tool-belt, from which users can extract and exchange tools. This is shown in FIGS. 8A-8D and described as follows: When a cursor is in proximity to a holster (FIG. 8A), a green animated timeout ring appears and starts to fill around the icon (FIG. 8B); if the cursor is moved away before the ring is full (before the timeout ends), the docking process is canceled; When the timeout ring is full and the timeout ends, the cursor's icon changes to a much smaller size (FIG. 8C), and the dockable icon moves to follow the cursor position, augmenting the cursor icon with the tool icon. At the same time, the holster's sphere icon reappears, indicating that it is empty and ready to accept a tool (FIG. 8D). Once a tool is docked with a cursor, the tool will only function in wallspace; a user in userspace must move forward in the workspace to use it, and a user in wallspace can use it immediately. In this manner, the cursor embodies the tool and takes on its behavior for interaction with geometry. When a user is finished using a tool he or she can re-holster it. The user holds the cursor (with docked tool) in proximity to an empty holster, the animated timeout expires, and the tool icon replaces the holster icon, with the cursor icon reverting to its original size. Tools are prevented from being re-holstered instantaneously by another timeout without a visual cue.

The system also defines another class of virtual entities called “actables.” Unlike tools, actables do not dock to cursors, instead, they behave like proximity-activated buttons and can trigger discrete events when a cursor is near. Actables are best utilized when attached to a given type of tool. This can be done by docking an actable to a tool attached holster. Since the actable cannot dock to a user's cursor, it cannot be removed from its initial holster and is effectively locked to the tool. In this case, the actable can trigger a tool-specific function or change the mode of the associated tool. An example of a tool-docked actable is shown in FIG. 8B.

There are fundamental usability challenges when defining interaction behavior based on proximity and dwell time in the way that we do with dockable tools and actables. When a user reaches for a given tool or actable, the region in which he or she can activate the object may be unclear. Reaching performance in 3D virtual environments is can be described by Fitts' Law, which states that the time MT it takes to move to and acquire a target of width W at a distanced away from the starting position can be computed by

$$MT = a + b {log}_{2} ( \frac{D}{W} + 1 ) \qquad ( 1 )$$

where a and b are constants determined empirically. The reciprocal of b is related to the user's “rate of information processing” or bandwidth, and the log term is denoted as the index of difficulty. Essentially, Fitts' law states that for a smaller target, further away from the user's cursor position, it will take either more time or more mental bandwidth from the user to move his or her cursor there.

In the framework of the present invention, interaction between geometric elements (tools, cursors or holsters) is governed by a timeout, a wait period triggered by proximity, which makes inter-object interaction a non-instantaneous event. This allows the user to change their mind (by moving the cursor away, as described in the “Docking” section) and prevents accidental events. The present invention uses a gradient proximity timeout. The duration of the timeout decreases as the user's cursor gets closer to the tool. This effectively increases the size of the target, without distracting the user, and while preventing false activations. This function is used for changing the timeout duration based on distance:

if D<d; tₐ=D³t_{b} (2)

where tₐ is the actual time, t_{b} is the base time, D is the distance from cursor to target and d is the upper bound (threshold) on distance.

The wall display used in this study does not support 3D viewing, but rather displays a projection of a 3D environment on 2D displays, so the problem of depth perception in reaching for and interacting with objects must be addressed. First, linear perspective cues from a 3D render engine like the relative size of objects are leveraged. Second, geometry objects are made transparent when they are being manipulated. This enables the user to see the cursor inside the active geometry.

A cursor in front of the object is shown in high contrast, inside the object in reduced contrast, and behind the object partially or totally occluded. Finally, the user can sense depth intuitively through his or her own proprioception. The static 3D mapping between the physical and virtual workspace is used to map the proprioception of the user into the 3D space.

An exemplary wall display, which could be used with the present invention, consists of an array of twelve 40in NEC p402 displays designed specifically for wall display applications. Each display has a resolution of 1920×1080 pixels with 0.5 inch bezels. The screens are arranged in a 4×3 configuration, yielding a total area of 13 ft×5 ft and a combined resolution of 7680×3240 pixels or just under 25 megapixels. These monitors can also correct for bezel visual distortion, where the bezels are made to appear to “cover up” content behind them like a paned window. This occlusion was deemed to be more acceptable than content “jumping” across bezels, without compensation enabled. Any other suitable large scale wall display known to or conceivable by one of skill in the art could also be used.

Sensing is accomplished by a single low cost Kinect (Microsoft Corp.) centered at the top of the screen, at a height of roughly 8 ft. The Kinect is a single depth camera, providing a 640×480 depth map and RGB image of the area within its field of view. The workspace of where users can be continuously tracked by the Kinect is approximately 6 m². The Kinect can also track joint positions (skeletons) of up to 6 users. This includes shoulders, elbows, hands, torso, head, hips, knees, and feet. Notably, the Kinect does not track the wrist or ankle joints of the user. Therefore, any other suitable depth camera known to or conceivable by one of skill in the art can also be used. In an exemplary embodiment the wall display is driven by a single machine, rather than by several networked machines. A Tyan 6U server chassis contains dual 6-core Intel Xeon processors, running at 2.4 GHz, 16 Gb of DDR3 RAM, 6 nVidia FX4800 graphics cards and a 4 Tb redundant raid array (6×1 Tb hard drives, RAID 6). The system runs Ubuntu Linux 10.10 with Xinerama creating a single logical display from the twelve monitors. Any other suitable system known to or conceivable by one of skill in the art could also be used.

An example of software used to operate the framework is built on four software frameworks: OpenNI provides access to the Kinect and its data; the Primesense NITE library interacts with OpenNI to provide Kinect skeleton tracking; Qt provides simple, scalable graphical elements and layout capability, and Open SceneGraph allows for 3D applications. A high level framework called the Surgical Assistant Workstation (SAW) is also used for accessing OpenNI and NITE. This exemplary software simplifies authoring of 2D and 3D applications that run at full wall resolution, either using explicit interaction from the Kinect skeletons, or implicit interaction using the Kinect depth or RGB images. While this software structure is included as an example, it is not meant to be considered limiting and any other suitable software structure could also be used.

The OpenNI Kinect capability is also wrapped into a LAIR user handler which keeps track of user state, whether they are active users or bystanders, and their whereabouts in the workspace. Additionally, the Kinect's joint tracking can be fairly noisy, due to noise in the depth image. A simple low pass filter can therefore be used to smooth the joint positions without introducing significant delay.

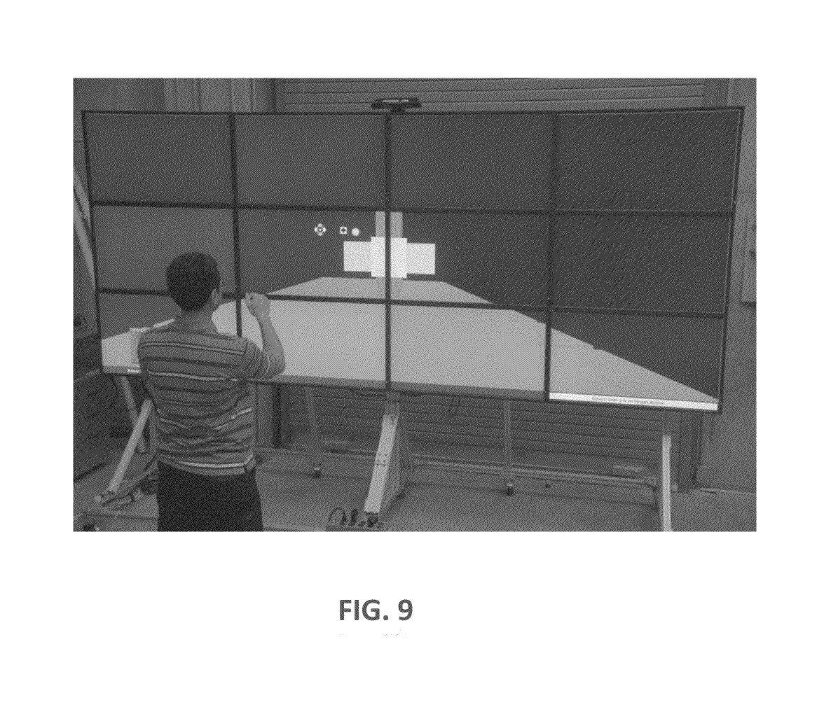

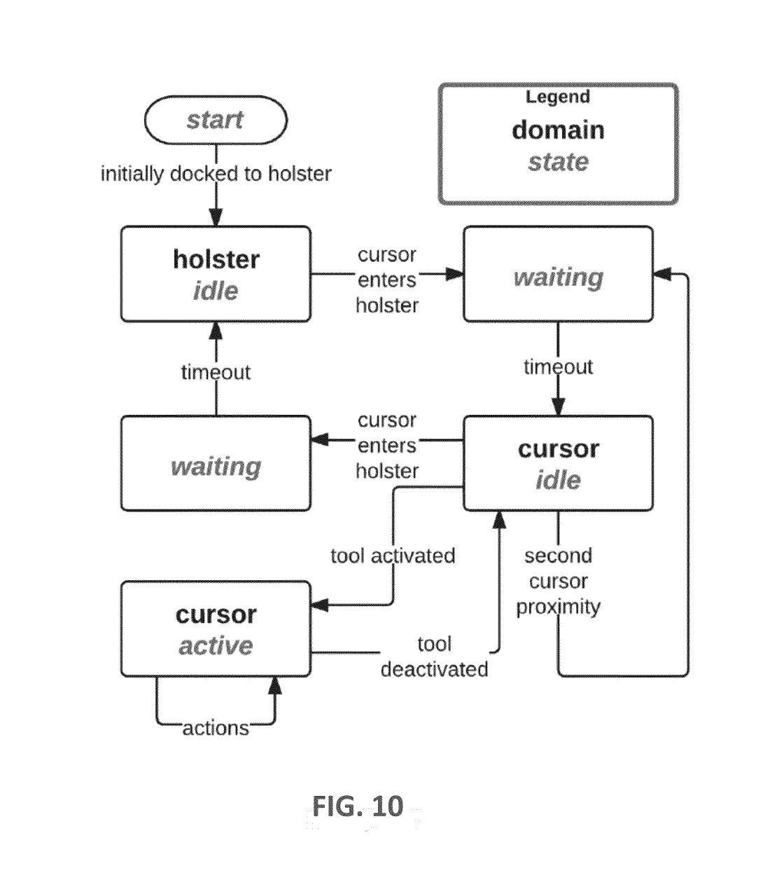

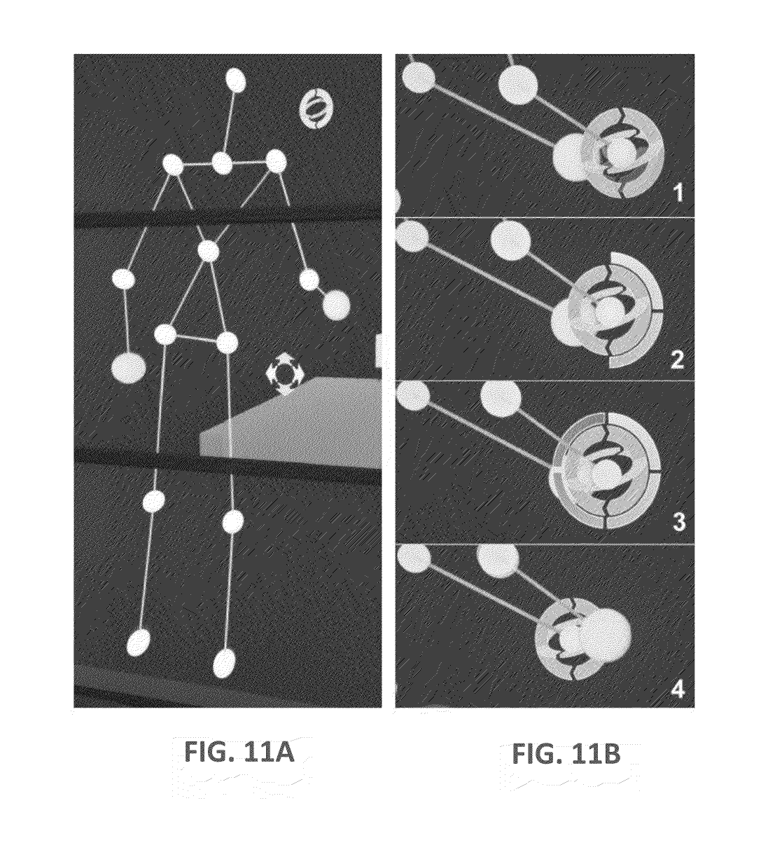

In an exemplary implementation of the framework of the present invention, a simple 3D object manipulation application was created. The application consists of a scene containing several differently colored cubes spread out over a 3D region. As mentioned above, tools can be unholstered and docked when the user is either in the wallspace or userspace regions, but can only be used in the wallspace region. Tools allow the manipulation of cubes, as well as the environment. This application is only a minimal example necessary to explore the aforementioned interaction paradigms, and an overview of the application is shown in FIG. 9. FIG. 10 illustrates a schematic diagram for a dockable tool according to the exemplary embodiment. FIG. 10 also illustrates that when the user switches from one tool to another, the tool returns to the idle state, but the cursor ID changes. FIG. 11A illustrates two possible locations for holsters at the shoulder and the hip and FIG. 11B illustrates the action of the user switching tools between hands.

Tools imbue the docked cursor with additional functionality. In the experimental application, there are two tools available to the user: a tool for moving geometric objects and a tool for rotating the view of the virtual environment. The icon for the geometry move-tool is shown in FIG. 8B. Moving a cursor with a docked move-tool into a cube will attach the cube to the cursor. An actable is attached to the move-tool, represented by a white cross-hair icon (see FIG. 8B). To release the attached cube, the user moves his or her other cursor into the actable crosshair. After a short timeout to prevent immediate re-engagement, the tool is again ready to be used to move another cube. In this manner, the cube can be picked up and placed anywhere in the reachable workspace.

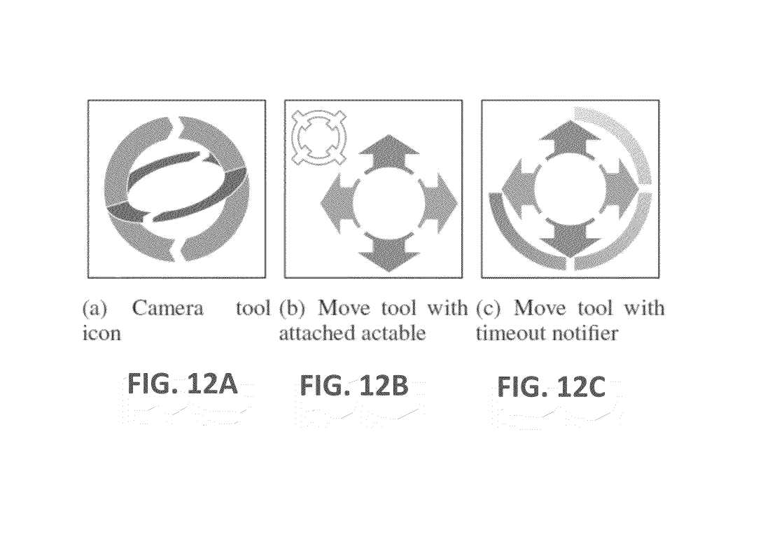

The camera-tool, which rotates the scene in spherical coordinates, shown in FIG. 12A, rotates the view of the virtual environment about a point in the middle of the scene. The tool is activated when a user holds his or her hand greater than a distance d from his or her body along the Z axis towards the wall. The tool initially saves a 2D starting point relative to the user: S=(Sₓ; S_{y}). If the X or Y position of the user's hand exceeds the deadband zone, the corresponding spherical coordinate scene view angle is incremented by sign(X−Sₓ) * I where I is a set constant. Body-relative X and Y motion map to world-relative spherical angles θ and φ respectively. If the user pulls back their hand less than d, the tool resets S, which allows the user to reposition their arm without changing the camera angle. The workspace is set up so that using rotation alone, the user can reach every cube in the virtual environment.

Additionally, a user can swap tools between cursors. This is accomplished by holding a cursor with a tool near an empty cursor, and after the normal holstering timeout, the tool will switch to the empty cursor. This is shown in FIG. 12B In the case of the move-tool, the actable icon with will switch sides when the tool switches hands to accommodate its use with the contralateral hand. FIG. 12C illustrates the move tool with time-out notifier.

For multiple users, the partitioned workspace behaves similarly to a single user. However, the transition is handled in a first in-first out manner. For instance, if both users A and B are in wallspace and user B moves into userspace, the view of the environment and the interface mapping will switch to userspace, even though user A is still in wallspace. User A's mapping to the workspace changes to match the userspace paradigm. In other words, user B's action in wallspace suspends user A's actions in wallspace.

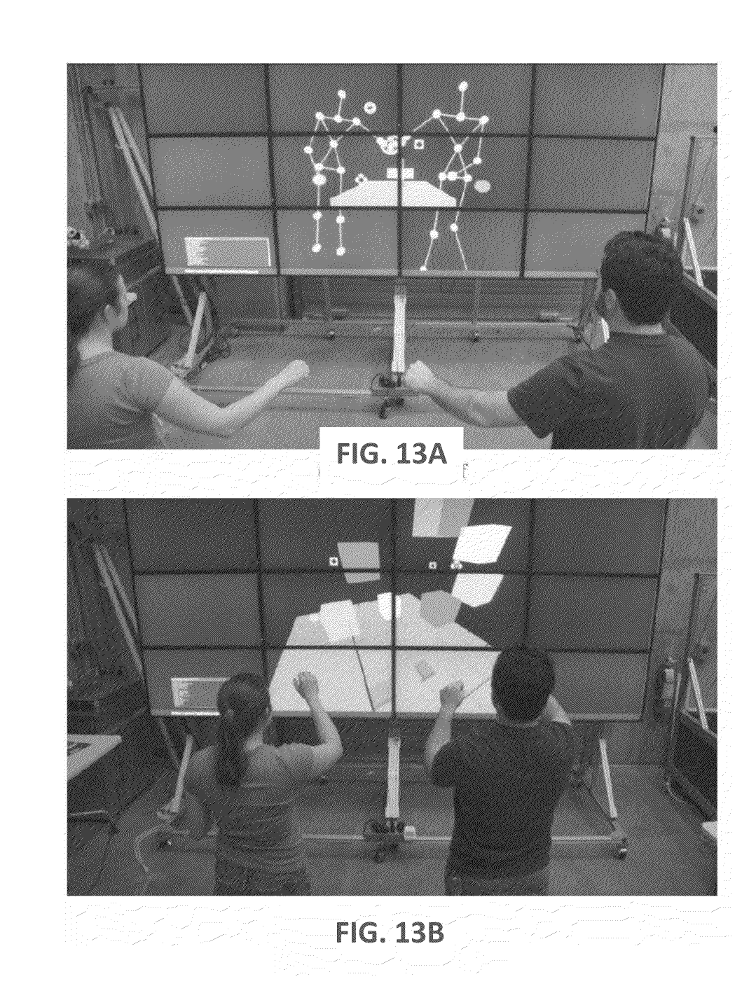

The dockable tool object is agnostic to which cursors or holsters it will dock to, multi user tool passing is as simple as the single user cursor tool switching described above. A user can bring their cursor in proximity to the other user's cursor, and after a short timeout, the tool will switch to the other users cursor. Tool passing can happen both in wallspace and userspace, however, both users must inhabit the same space for passing to be possible. FIG. 13A shows the first user passing a tool to the second user. It is also worth noting that a user can unholster tools from the other user's holster. This can be desirable if the first user needs assistance, and wants the second user to perform a concurrent task which the he or she is not equipped for.

Multiple users can concurrently use tools. For instance, both users could be using the move tool to translate geometry around in the scene. Conversely, one user could “grab” a cube with the move tool while the other user changes the workspace view angle or zoom. FIG. 13B shows two users concurrently using tools; both users have docked and equipped move tools and are manipulating geometry.

The system can also be enhanced to address the issue of reduced visual feedback for proprioceptive holstering by adding a similar timeout animation in wallspace. Ownership of tools in a multiuser scenario can be addressed by using keyed tools, tools which are can only be used by a single user or a group of users. Tools might be tethered to a single user, and prevent other users from docking with them. Users can also independently move from userspace to wallspace and vice versa. Tools which multiple users can be docked to simultaneously could affect different behavior depending on a whether single or multiple users are using it. Further tools are planned, including tools for manipulating geometry (position, rotation and scale) with handles and creating new geometry with vertex or polygon editing. A fully featured CAD package for large wall displays can also be used. The present system can be used for entertainment, training, virtual reality, CAD, architectural, and many other potential applications. Therefore, it should not be considered limited to a single application. Therefore, the system can be used in conjunction with any application, activity or discipline known to or conceivable by one of skill in the art.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of providing three-dimensional interaction with a workspace displayed on a large-scale wall display comprising:
providing a non-transitory computer readable medium programmed for:
capturing a user's movements;
translating the user's movements into a first command to remove a dockable virtual tool from a holster;
translating the user's movements into a second command to move and use the tool; and
translating the user's movements into a third command to return the dockable virtual tool to the holster.

2. The method of claim 1 wherein the tool further comprises at least one chosen from the group consisting of a tool to move geometry, a tool to scale geometry, a tool to rotate geometry, a tool to create new geometry, a tool to delete geometry, a tool to augment geometry, and a tool to perform Boolean operations on geometry.

3. The method of claim 1 further comprising the holster being attached directly to a user's avatar in the workspace.

4. The method of claim 1 further comprising using proprioceptive cues for accessing tools.

5. The method of claim 1 further comprising using an actable to trigger discrete events when a cursor controlled by a user is nearby.

6. A method of providing three-dimensional interaction with a workspace on a large-scale wall display comprising:
providing a non-transitory computer readable medium programmed for:
providing a dockable virtual tool in the workspace, wherein said dockable virtual tool resides in a holster when said dockable virtual tool is not in use;
partitioning the workspace into a first region and a second region, said first region configured for a user's interaction with geometry within the workspace, and said second region configured for management of the dockable virtual tool;
capturing the user's movements; and
translating the user's movements into a command to control the dockable virtual tool.

7. The method of claim 6 wherein the tool further comprises at least one chosen from the group consisting of a tool to move geometry, a tool to scale geometry, a tool to rotate geometry, a tool to create new geometry, a tool to delete geometry, a tool to augment geometry, and a tool to perform Boolean operations on geometry.

8. The method of claim 6 further comprising the holster being attached directly to a user's avatar in the workspace.

9. The method of claim 6 further comprising using proprioceptive cues for accessing tools.

10. The method of claim 6 further comprising using an actable to trigger discrete events when a cursor controlled by a user is nearby.

11. A system for providing three-dimensional interaction with a workspace on a large-scale wall display comprising:
a single-range camera configured and positioned to collect movement data from a user;
a non-transitory computer readable medium programed to execute steps comprising:
displaying a virtual dockable tool on the large-scale wall display;
displaying a holster for holding the virtual dockable tool when said virtual dockable tool is not in use; and
translating the movement data from the user collected by the single-range camera into commands to control the virtual dockable tool.

12. The system of claim 11 wherein the tool further comprises at least one chosen from the group consisting of a tool to move geometry, a tool to scale geometry, a tool to rotate geometry, a tool to create new geometry, a tool to delete geometry, a tool to augment geometry, and a tool to perform Boolean operations on geometry.

13. The system of claim 11 further comprising the holster being attached directly to a user's avatar in the workspace.

14. The system of claim 11 further comprising the tool being controllable with proprioceptive cues.

15. The system of claim 11 further comprising an actable configured to trigger discrete events when a cursor controlled by a user is nearby.
